(19) United States
(12) Patent Application Publication
(10) Pub. No.: US 2016/0196347 A1
(43) Pub. Date: Jul. 7, 2016

(54) Efficient Dataset Search

(71) Applicant: Microsoft Technology Licensing, LLC, Redmond, WA (US)

(72) Inventors: Chairy Chiu Ying Cheung, Redmond, WA (US); Taurean Addair Jones, Issaquah, WA (US); Amir Netz, Bellevue, WA (US)

(21) Appl. No.: 14/589,822

(22) Filed: Jan. 5, 2015

(51) Int. Cl. G06F 17/30

(52) U.S. Cl. CPC G06F 17/30864; G06F 17/30398

(57) ABSTRACT

Efficient display of search results. A method includes receiving a query specifying a search object for a dataset. Data items in the dataset are able to be viewed or navigated to in an active region of a user interface. The active region is a portion of a display which is primarily configured for use by a user to view, navigate to for viewing, add, remove or edit the data items in the dataset. The method rearranges data items in the dataset to aggregate together data items of the dataset that include a match for the search object. The method includes providing the rearranged dataset through the active region of the user interface, such that a user can view or navigate to the aggregated data items in the dataset as well as other data items in the dataset.

### BACKGROUND

Computers and computing systems have affected nearly every aspect of modern living. Computers are generally involved in work, recreation, healthcare, transportation, entertainment, household management, etc.

Computing systems can be used by users to access and manipulate data. For example, a broad range of users, from power users to novice users can use word processing and spreadsheet applications to create, store, and manipulate data. These applications have various features that make manipulating and searching data efficient and intuitive. However, in various applications, such as word processing and data processing applications, search and replace is often a clunky experience.

Applications have functionality for searching for, and replacing a string by stepping through a document and replacing each instance of the string one by one. This allows for the context of each replacement to be maintained, but requires consideration of each replacement in isolation with respect to other instances of the string or similar strings. In other words, each search and replace operation is performed one instance of a search result at a time.

Alternatively, a user can replace all instances in a single operation, but without the benefit of seeing the changes in context. Rather, the application simply replaces all instances of a string with a replacement string.

In addition, existing applications are limited in what can be searched and replaced. For example, some applications may only allow a user to specify a text string as a search object and a text string (or an object that can be expressed as a text string, such as a formula) as a replacement object.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method that may be practiced in a computing environment. The method includes receiving a query specifying a search object for a dataset. Data items in the dataset are able to be viewed or navigated to in an active region of a user interface. The active region is a portion of a display which is primarily configured for use by a user to view, navigate to for viewing, add, remove or edit the data items in the dataset. The method rearranges data items in the dataset to aggregate together data items of the dataset that include a match for the search object. The method includes providing the rearranged dataset through the active region of the user interface such that a user can view or navigate to the aggregated data items in the dataset as well as other data items in the dataset.

Another embodiment includes a method for searching a dataset. The method includes identifying one or more user specified search objects. The method further includes identifying search results in the dataset based on the search objects according to predetermined result criteria. The method further includes sorting the search results according to a similarity measure to the search objects. The method further includes providing the sorted search results to a user in an active region of a representation of the dataset.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered limiting in scope, embodiments will be described and explained with additional specificity and detail through the use of the accompanying drawings in which:

FIG. 1A illustrates a document user interface illustrating a document in an active region of the user interface;

FIG. 1B illustrates the document user interface where paragraphs have been sorted by search results in the paragraphs;

FIG. 2A illustrates the document user interface;

FIG. 2B illustrates the document user interface with paragraphs sorted by search results in order of lexical nearness to a search term;

FIG. 3A illustrates a spreadsheet user interface with an active region;

FIG. 3B illustrates rows with search results in them sorted at the top of the active region in the spreadsheet user interface;

FIG. 3C illustrates a global replacement operation shown on search results in context with columns in which the search results appear;

FIG. 3D illustrates a search result which does not have a replace operations performed as a result of the search result being marked as an exception;

FIG. 4A illustrates fine grained searching in the context of a spreadsheet user interface;

FIG. 4B illustrates additional fine grained searching in the context of a spreadsheet user interface;

FIG. 4C illustrates additional fine grained searching in the context of a spreadsheet user interface;

FIG. 5 illustrates a system for sorting search results in a document;

FIG. 6 illustrates a method of more efficiently displaying search results to a user; and

FIG. 7 illustrates a method of searching a dataset.

### DETAILED DESCRIPTION

Some embodiments of the invention may implement features that can solve a technical problem that exists when search results are not displayed in sufficient context. In particular, when search results are not displayed in sufficient context, users interact more inefficiently with computing systems. The user may need to provide additional input to see search results. Such input can be particularly costly in terms of hardware resources usage. In particular, direct human interaction with computing resources is expensive in terms of processing power, memory usage, and power usage.

The technical effects of improving user efficiency (and/or more efficient use of a display region of a user interface) and resulting more efficient user interaction with a system to interact with search results can be achieved by the technical means of a search engine identifying search result instances in a dataset, such as a document, spreadsheet, database, etc., and rearranging portion of the dataset such that the active region of a user interface can be used to view or navigate to grouped search results instances. The active region is a portion of a display in which is primarily configured for use by a user to view, navigate to for viewing, add, remove or edit data items in a dataset. The active region is, for example, the document viewing window in a word processing document or the workbook viewing window in a spreadsheet program. Data items in a dataset can be rearranged so that the active region can be used to view or navigate to the data items in the dataset that have been rearranged based on search results. All of the data in the dataset can still be viewed or navigated to (i.e. data items from the dataset are not filtered out of the dataset, rather merely rearranged), but search results are grouped together such that a user could view or navigate to the grouped search results.

In some embodiments, the active region specifically excludes ancillary interface elements that are separate from the active region (such as separate windows) primarily configured to allow a user to view only select portions of the dataset, while excluding other portions of the dataset based on search terms. However, in some other embodiments, the search results may be considered the dataset, and the search window as the active region. In this case, data items in a dataset may be rearranged based on additional search terms. In the search window example, the original search terms (i.e. the data items in the search dataset) can be viewed or navigated to in the search window, but can be rearranged by specifying additional search terms. None of the previous search results would be filtered out, just simply rearranged based on the additional search terms.

Rearranging the displayed active region of the representation of the dataset to group search results instances together allows the user to more efficiently view, evaluate, and perform editing operations based on search result instances in a context in which they occur by preserving an overall context while still allowing results to be grouped. By being able to more efficiently view, evaluate, and perform editing operations, the system performance can he improved as user interaction can be reduced leaving resources available for other tasks.

For example, in an unstructured data document, such as a word processing document, the active region of the document may be rearranged such that document paragraphs in the document active region are grouped where paragraphs with an instance of a search result are grouped together. In a structured data document, such as a spreadsheet document, rows (or columns) having an instance of a search result may be grouped together such that a given search result can be evaluated in the context of an entire row (or column) and such that different instances of search results can be evaluated more efficiently by grouping rows (or columns), each having a search result instance, together. The remaining un-grouped can be viewed, or can be navigated to using the active region of the user interface.

This can help to decrease a user's mental effort as search results can be evaluated together without requiring the user to shift their attention across large swaths of a representation of a dataset. Further, the user's physical efforts can be reduced as there is less effort in using navigational interaction, such as manual scrolling of representations of datasets, large gesture movements, or large eye fixation changes to identify and evaluate different search result instances. Decreases of navigational interaction can preserve system resources. In particular, as a user interacts with a system less, less system resources will be needed to handle the user interactions.

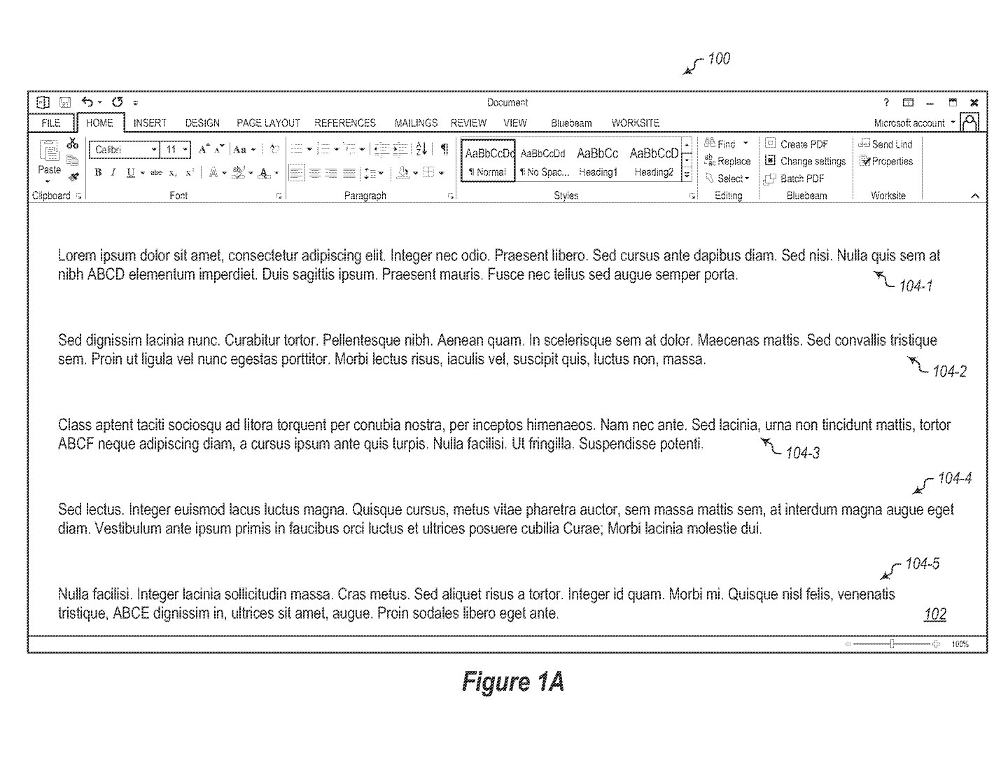

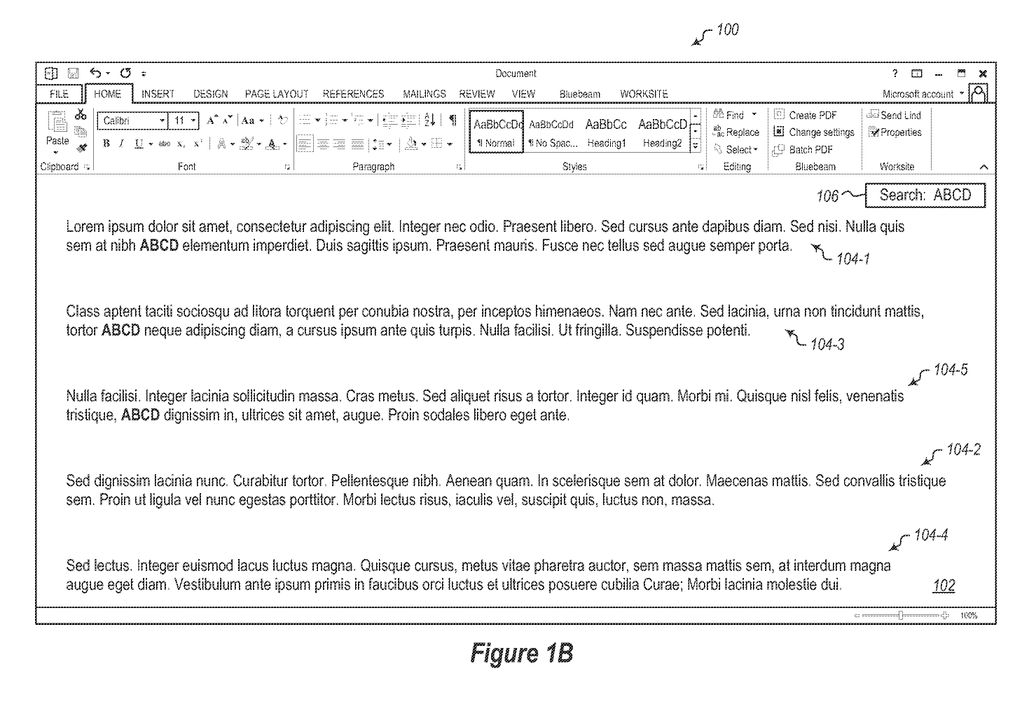

Referring now to FIG. 1A, a user interface 100 is shown. The user interface 100 includes an active region 102. The active region 102 displays a representation of a dataset, which in the illustrated case is a text document. The active region 102 is a region of the user interface 100 in which a user can interact with the document. In one embodiment, the user can view and edit document text in the active region of the user interface 100.

The document is divided into paragraphs 104--1, 104-2, 104-3, 104-4, and 104--5. In the illustrated example, each of the paragraphs includes the text “ABCD”. As illustrated in FIG. 1B, a user enters the search string “ABCD” in a search box 106. The system is able to match the search sting “ABCD” with instances in the document of this string. In addition, as illustrated in FIG. 1B, the paragraphs of the document are rearranged in the active region 102 so that all of the paragraphs with the search result “ABCD” are grouped together in the active region 102 of the document. In one embodiment, the paragraphs matching the search query are grouped and distinguished from the rest of the dataset, such as by highlighting the matched paragraphs, creating a boarder encircling the matched paragraphs, greying out the unmatched paragraphs, hiding the unmatched paragraphs, using any other known techniques, or any combinations of the above.

Notably, search result instances for a given search are not necessarily identical. Rather, the search result instances for a given search may be related by some search criteria. Thus, for example, search result instances may be grouped when the results are sufficiently similar to each other. Sufficient similarity may be determined in a number of different fashions. For example, synonyms of a search term may be included in search results. A lexical threshold distance, such as a maximum Levenshtein distance, may be established and any string in a document within the threshold distance may be included in search results for a search string. In a formula search, formulas may be grouped by overall operational equivalency or similarity. Thus, for example, a logical formula NOT (A OR B) may be grouped with the equivalent formula NOT A AND NOT B, etc.

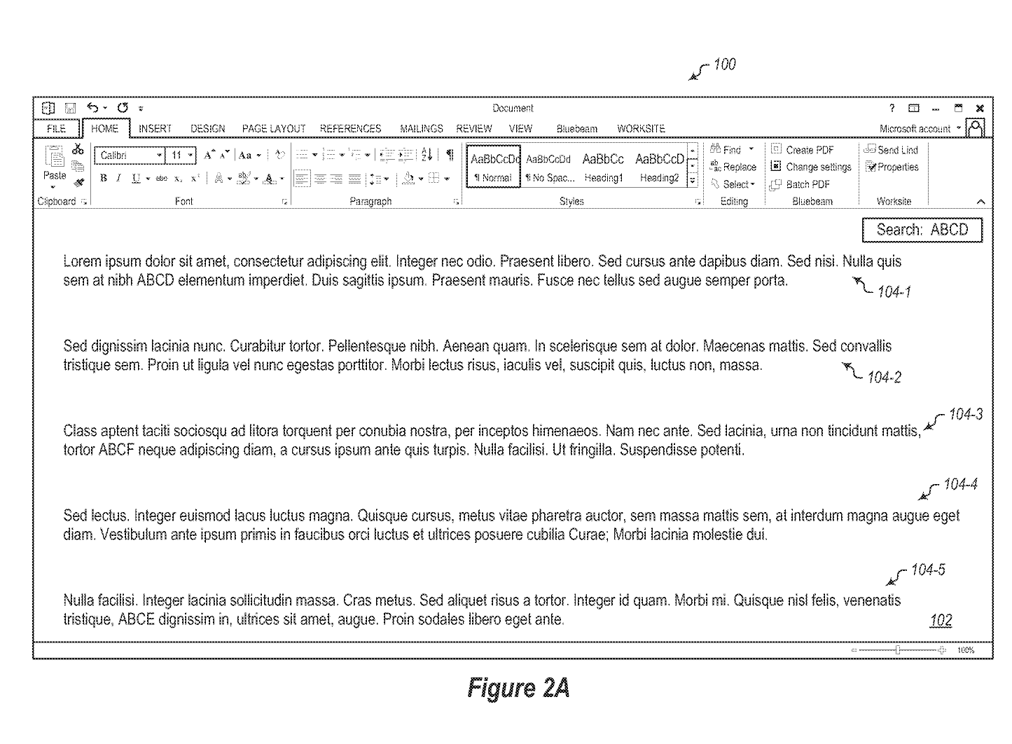

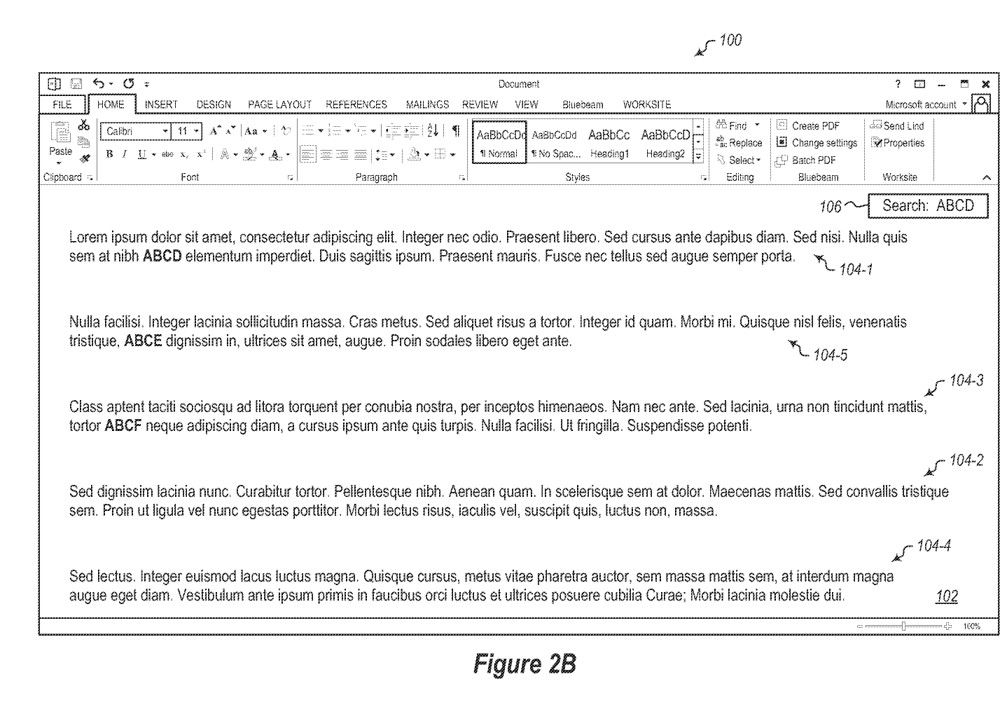

An example of grouping similar search results is illustrated in FIGS. 2A and 2B. FIG. 2A illustrates that paragraph 104-1 includes the text “ABCD”. Paragraph 104-3 includes the text “ABCF”. Paragraph 104-5 includes the text “ABCE”. In FIG. 2B. FIG. 2B also illustrates a search box 106 with the search term “ABCD” entered into the search box 106. FIG. 2B illustrates two principles with respect to similar but not identical search results. First, FIG. 2B illustrates that similar search results can be grouped together. Second, FIG. 2B illustrates that search results can be sorted within the grouping by similarity to the original search object.

Thus, for example, FIG. 2B illustrates that the paragraphs are reordered such that paragraphs 104-1, 104-3 and 104-5 are grouped together based on each having a search result that is sufficiently similar to the original search term “ABCD”.

Additionally, the paragraphs are sorted by similarity to the original search object. Thus, in this example, paragraph 104-1 appears first because it has a search result with an exact match to the search term “ABCD”. Paragraph 104-5 is sorted to the next position as it has the next closest search result “ABCE”. Paragraph 104-3 is sorted in the next position as it has the match “ABCF” (where “F” is further, by some predetermined criteria, than “E” from “D”). Note that paragraphs 104-2 and 104-4 continue to be available for viewing in the active region 102, but are simply rearranged to allow the other paragraphs to be grouped together.

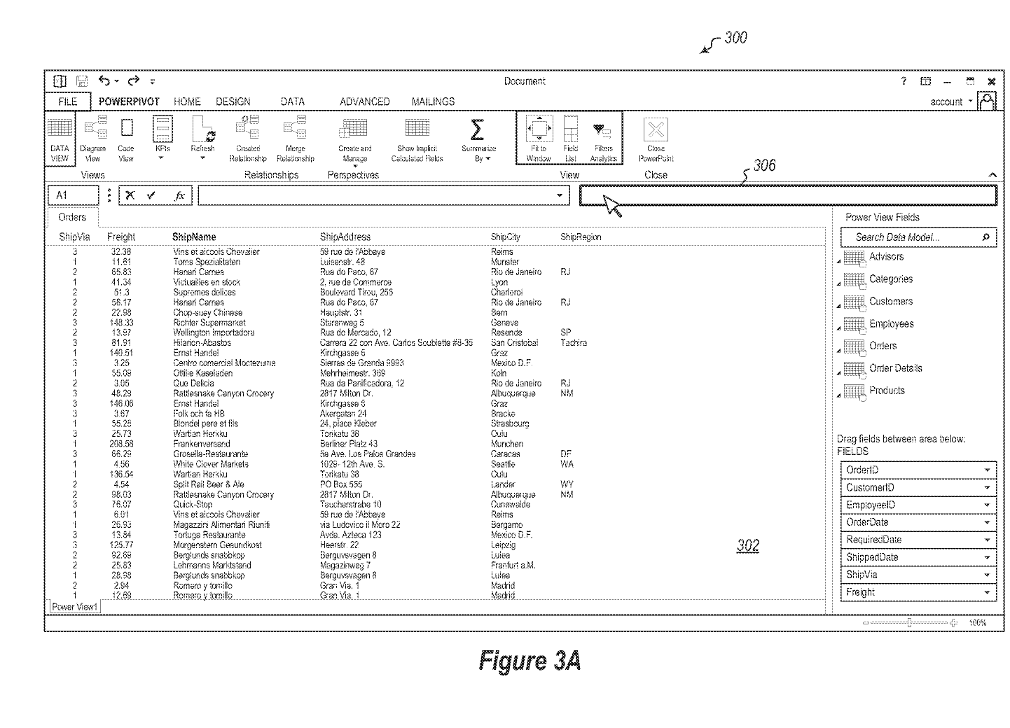

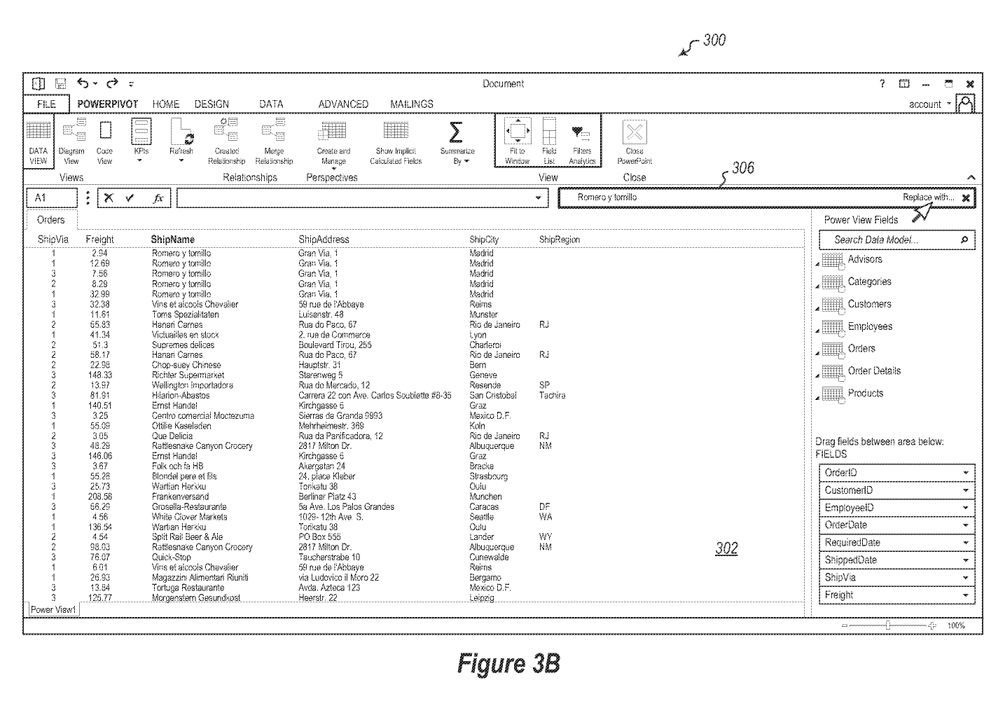

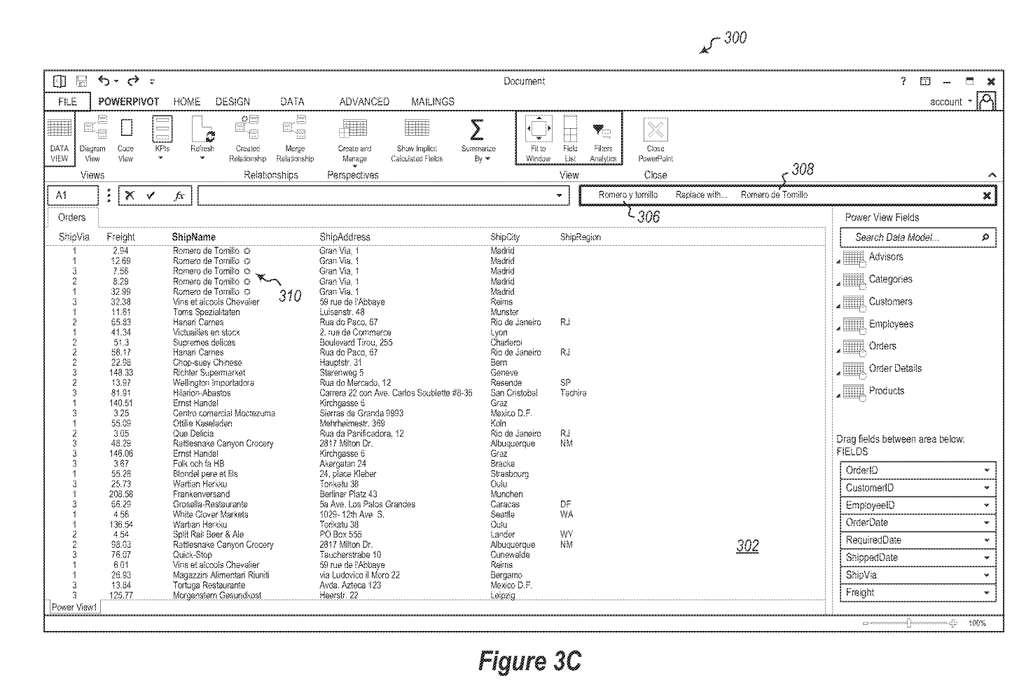

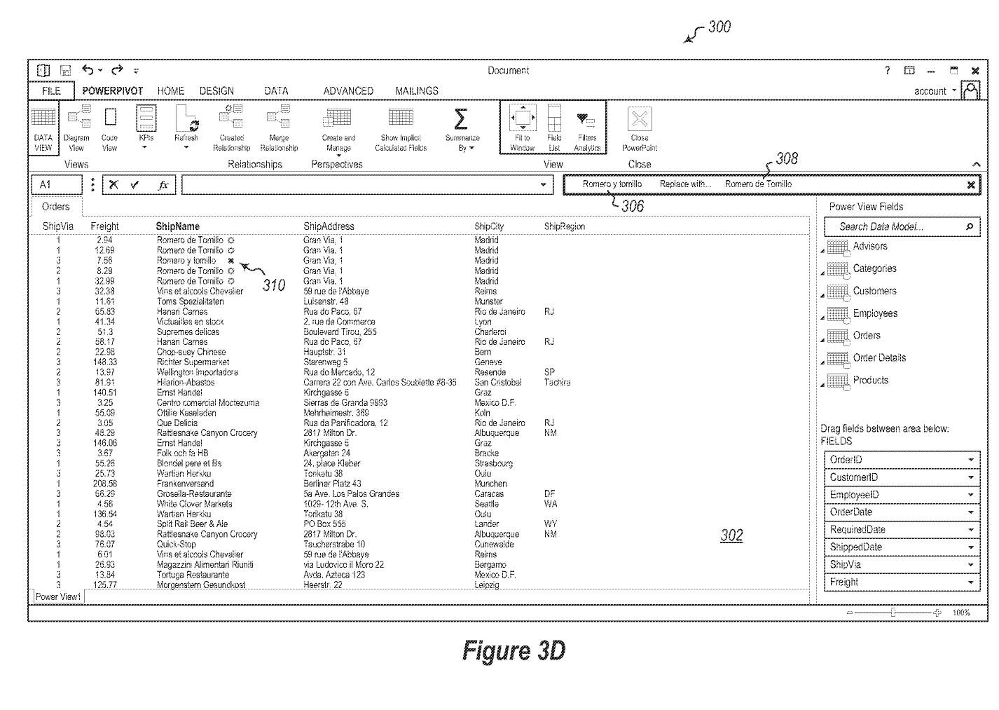

Referring now to FIGS. 3A-3C, a spreadsheet example is illustrated. FIG. 3A illustrates a user interface 300 with an active region 302 which includes a representation of a spreadsheet dataset. The user interface 300 includes a search box 306. FIG. 3B illustrates that a user enters “Romero y tomillo” into the search box 306. This causes the rows in the spreadsheet represented in the active region 302 to be sorted such that rows that have a cell with the search result “Romero y tomillo” are sorted to the top of the representation of the spreadsheet.

Embodiments may further include functionality for in-context replacement preview. In particular, a user can preview how a replacement will appear in all (or a subset) of the various search result instances in the active region of the user interface. For example, FIG. 3C illustrates a replacement box 308. A user can enter replacement text in the replacement box 308. In this example, the user types “Romero de Tomillo” in the replacement box 308 indicating that instances of “Romero de tomillo” should be replaced with “Romero de Tomillo”. This change is reflected in the search result instances shown in the active portion 302 of the user interface 300. The user can then review these changes in the original context, but also in context with other instances of search results. The user could then accept the changes by closing the replacement box 308 or some other appropriate action.

Some embodiments may include functionality for allowing a user to exclude certain search results from global replacement. For example, the replacement may be appropriate for some search result instances but not others. Thus, some embodiments may include user interface elements to select result instances to exclude from being replaced. For example, FIG. 3C illustrates a set 310 of element for the search results shown in FIG. 3C. Such elements could be check boxes, x's, highlight select, multiple select, etc. If the user wishes to exclude any of the search results from being replaced by a global replace operation, the user can simply select a corresponding element for a search result from the set 310 of elements, which will prevent that search result from being replaced in a global replace operation. An example of this is illustrated in FIG. 3D, which shows an element 310-2 selected, and the corresponding search result being unchanged, and thus does not match the text entered into the replacement box 308, but rather matches the original text.

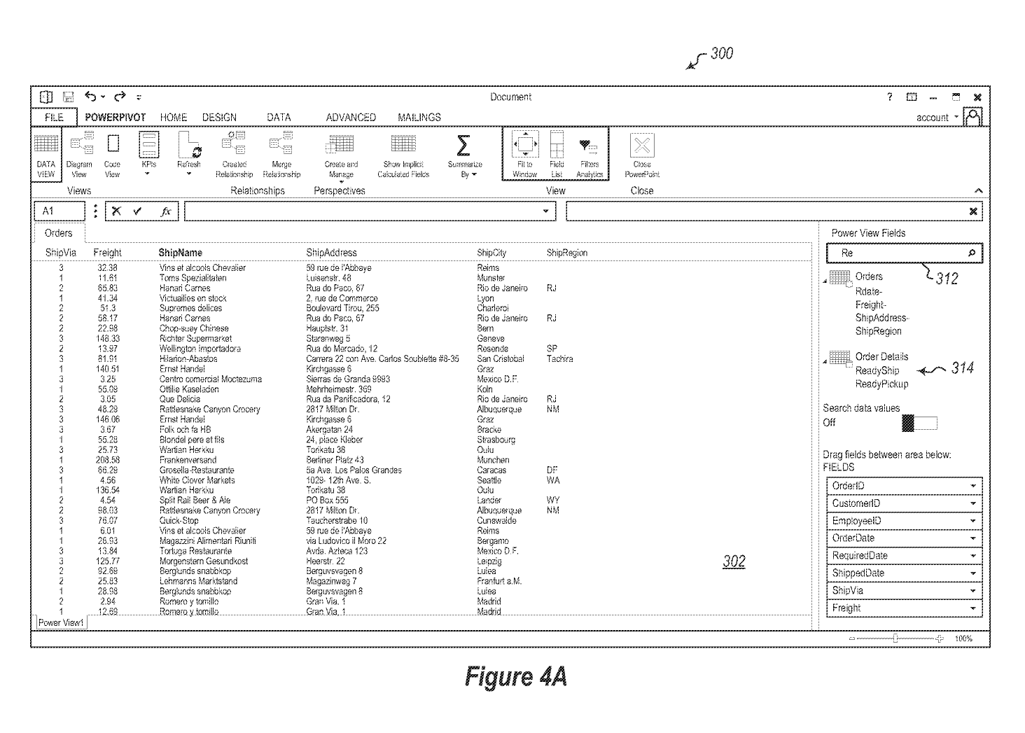

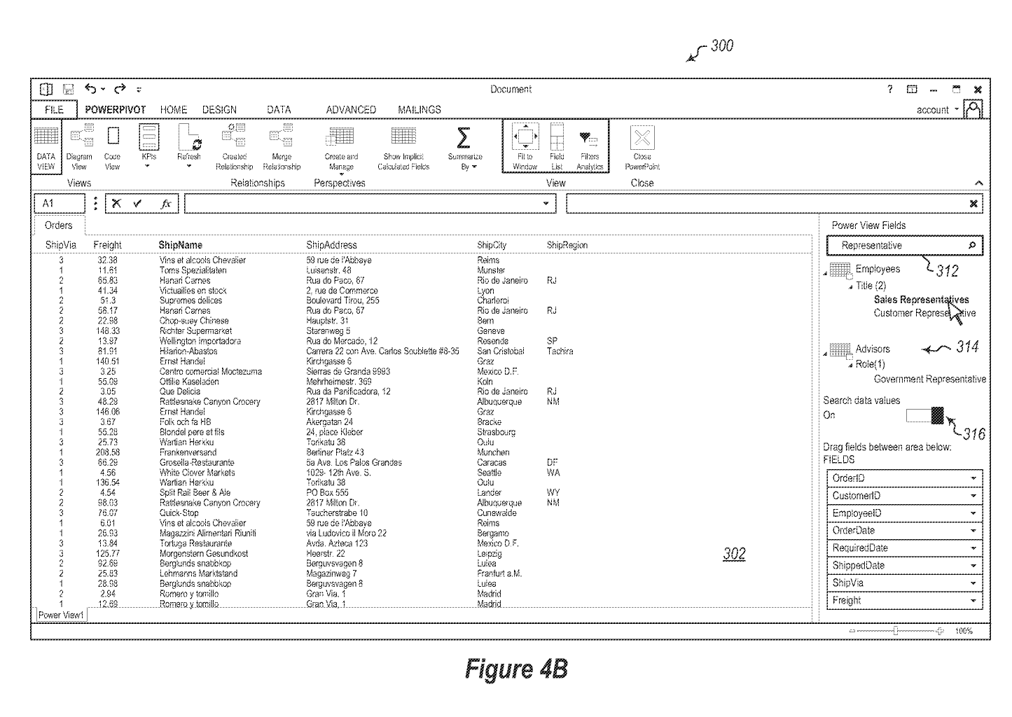

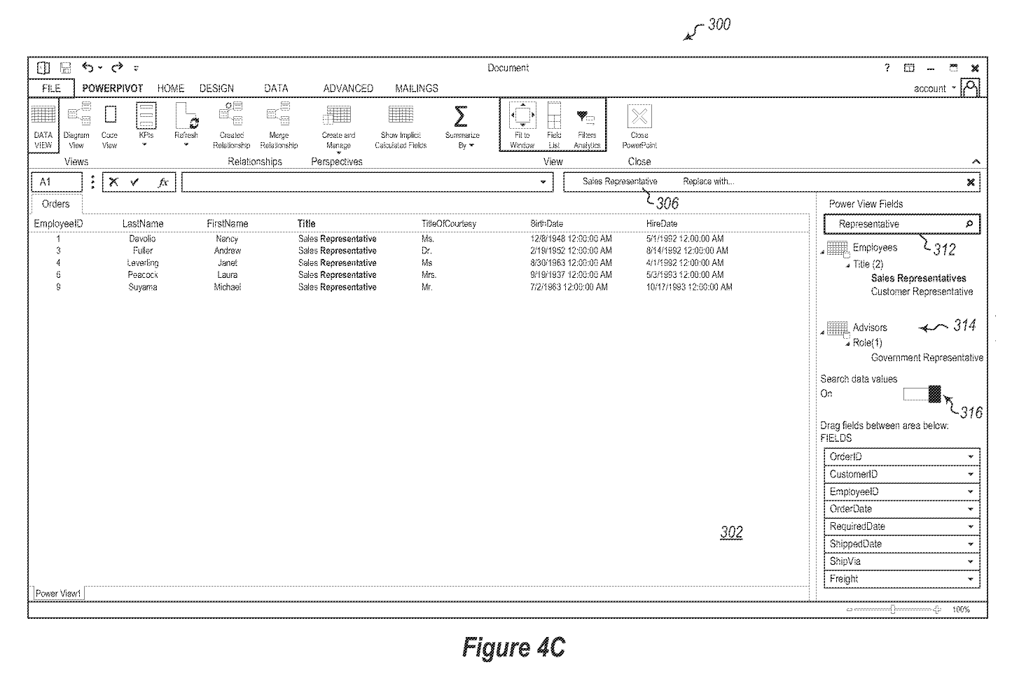

Embodiments may also include functionality for more precise searching, assisted searching and/or column searching. FIGS. 4A-4C illustrate some of this functionality. FIG. 4A illustrates a specialized search box 312 that can be used to search on a column basis in a spreadsheet. The specialized search box and associated functionality can be used to search for table titles (when multiple tables are present) column titles and/or data values as filtered by columns. For example, in the example illustrated in FIG. 4A, a user types in the text “Re” into the specialized search box 312. A results interface 314 indicates various columns and column metadata with matching text in an Orders dataset and an Order Details dataset. A user could select one of the illustrated matches to sort the columns by the search result.

However, FIG. 4B illustrates an alternate use, where user interface element 316 can be selected to indicate that searching should be done within entries in the columns themselves. Thus, in this example, the user enters “Representative” into the specialized search box 312. The user then selects the “Sales Representative” data entry from the Title column from the Employees dataset from the results interface. As illustrated in FIG. 4C, this pre-populates the search box 306 with the term “Sales Representative” and causes rows with the entry “Sales Representative” in their “Title” column to be sorted to the top of the data illustrated in the active region 302. As illustrated above, various replace operations could be performed once the search results have been identified. In cases with multiple tables, if the value selected by the user is not in the active view (e.g., not the currently selected table), the corresponding table will become active and in the active view. In the case where the column is not in the active view, embodiments can scroll to show the matching column.

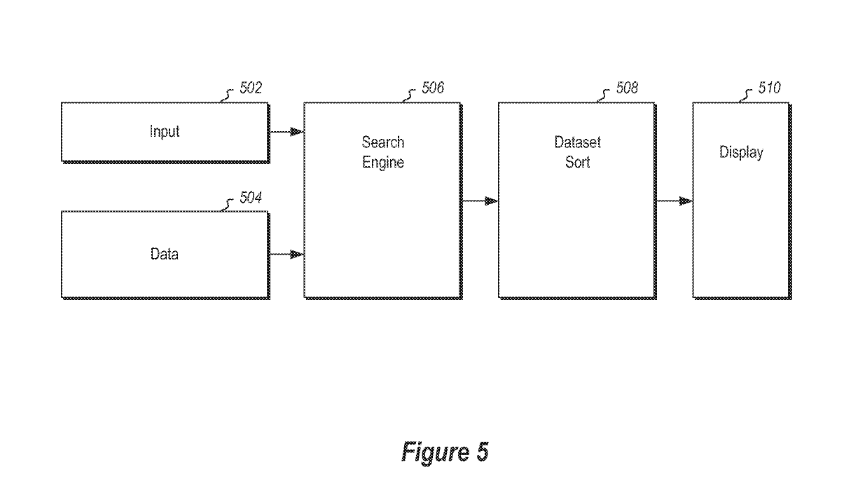

Referring now to FIG. 5, a system is illustrated. The system includes a user input module 502 for receiving user input. The user input module 502, for example, may include functionality for receiving user input specifying search terms and/or replacement terms.

FIG. 5 further illustrates data storage 504. The data storage 504 may store data for datasets for a user.

The input module 502 and data storage 504 are coupled to a search engine 506. The search engine includes functionality for identifying matches for search terms specified in the input module 502 in data in the data storage 504. This may include the use of various indexes, comparators, and other functionality to identify search results.

Search results may be provided to a dataset sort module 508. The dataset sort module 508 may sort dataset portions according to search results. For example, the dataset sort module 508 may sort paragraphs in a dataset based on search results in the paragraphs. As illustrated above, this may be done by ordering paragraphs with search results that match search objects (e.g., search terms) at the top of a document, spreadsheet or other dataset. Alternatively or additionally, results may be sorted based on relevance to search objects. Thus, search results do not need to match search objects exactly, and search results can be sorted according to how close they are to search objects. Dataset portions may be sorted, for example, by paragraph, sentence, row, column, or other appropriate context maintaining granularity.

FIG. 5 further illustrates a display 510. Search results may be displayed in the display 510. As noted, the search results may be viewed or navigated to in an active region of the display 510. The active region of the display is a portion of a display in which is primarily configured for use by a user to view, navigate to for viewing, add, remove or edit data items in a dataset. The active region is, for example, the document viewing window in a word processing document or the workbook viewing window in a spreadsheet program.

Some embodiments of the invention may include means for receiving a query specifying a search object for a dataset. Such means may include, for example, elements such as computer displays configured to display user interface elements or other hardware that provides user sensory output, such as audio or haptic feedback based devices. Such means may include hardware input devices such as keyboards, mice, trackballs, touch input sensors, tablets, motion detection hardware or other hardware configured to receive user interaction. Such means may further include various software modules such as graphical user interface modules and the like that allow for user input to be entered using various hardware and software.

Some embodiments of the invention may include means for rearranging the order of data items in the dataset to aggregate together a subset of the data items that include a match for the search object. Such means may include, for example, various software modules configured to search and/or sort data. For example, the search engine 506 and/or the dataset sort module 508 are specific examples of such means.

Some embodiments of the invention may include means for providing the rearranged dataset, including data items that have a match for the search object and data items that do not have a match for the search object through the active region of the user interface. Such means may include various software modules for organizing data items. Such means may farther include various software modules and hardware, such as video graphics adapters or other hardware for communicating information to a display device, such as a computer monitor or other display device. Such means may further include the display device itself.

The following now summarizes various aspects that may be implemented in various embodiments of the invention.

As illustrated previously herein datasets could be unstructured datasets such as word processing documents, structured datasets such as spreadsheets, database tables, or other appropriate datasets. Search objects could be strings, stings, formulas, images, metadata (including last modified, fonts, other formatting, etc.), column attributes, etc. Thus, for example, based on a search object, embodiments can look at one or more of field names, associated metadata, cell values, etc., to display matching results in a filtered list, and allow the user to replace searched value with another value in its context to another value which could be an arbitrary value, or a value derived from a regular expression or formula.

Features of some embodiments allow users to quickly see matching search objects in one place within the context that the search object lives. Search results may be aggregated and bubbled to the top of an active region displaying data.

Functionality of embodiments may allow users to preview changes in context on which objects live on a global replacement basis, such as with “replace all” functionality. Embodiments may have the ability to specify exclusions when doing a global replacement. Thus, certain search results may be excluded from global replacement,

Embodiments may include functionality that allows users to replace various types of search results with other types of objects. For example a text string may be replaced with an object of another content type, such as a formula, a regular expression, a model, an image, a video, an emoji or other content types that the application recognizes.

While the bulk of the examples illustrated above illustrate reordering paragraphs or rows based on a search object, the same principles can apply to reordering and/or sorting columns. For example, columns may be reordered by column names (e.g., alphabetically). Columns may be reordered by a specific attribute (e.g., by the number of distinctive values, number of null values, last modified date, etc.). A user may select a column (either in the same or different dataset) and embodiments would sort the rest of the columns in selected or otherwise specified table(s) by how related they are to the selected column. For example, columns may be sorted by a correlation value, mutual information, entropy, etc.

Sorting columns may be especially useful when a data scientist, for instance, is looking at a dataset with a large number of columns and wants to quickly make sense of information, identifying which columns are relevant to the problem s/he is solving.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

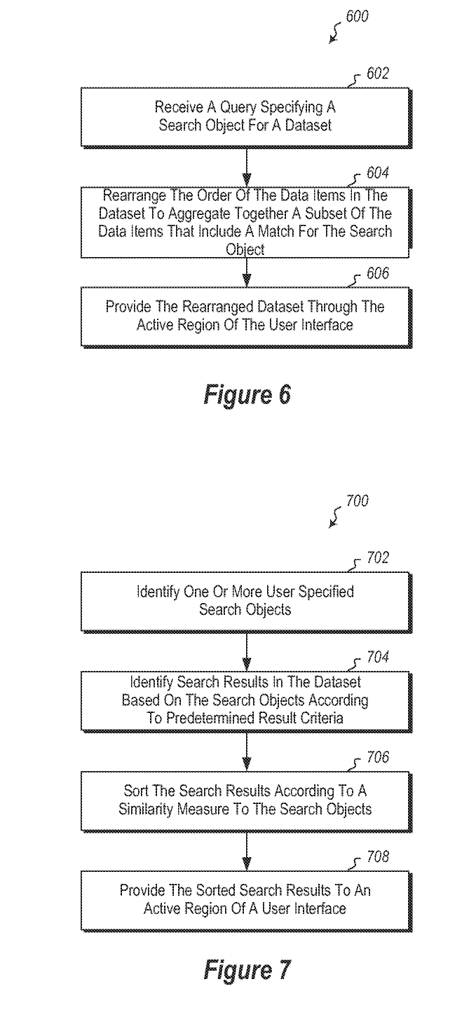

Referring now to FIG. 6, a method 600 is illustrated. The method 600 may be practiced in a computing environment. The method includes acts for more efficiently searching. The method includes receiving a query specifying a search object for a dataset, wherein data items in the dataset are able to be viewed or navigated to in an active region of a user interface (act 602).

The method 600 further includes rearranging the order of the data items in the dataset to aggregate together a subset of the data items that include a match for the search object (act 604). For example, as illustrated above, data items may be paragraphs, sentences, columns, rows, or any other appropriate excerpt.

The method 600 further includes providing the rearranged dataset, including data items that have a match for the search object and data items that do not have a match for the search object, through the active region of the user interface such that a user can view or navigate to the aggregated data items in the dataset as well as other data items in the dataset.

As illustrated in the examples above, the method 600 may be practiced where the dataset is a structured dataset, such as a word processing document. In some such embodiments, the method 600 may be practiced where each of the aggregated data items is a paragraph. Alternatively, such embodiments may be practiced where each of the aggregated data items is a sentence.

The method 600 may be practiced where the dataset is a structured dataset, such as a spreadsheet. In some such embodiments, the method 600 may be practiced where each of the aggregated data items is a row. Alternatively, the method 600 may be practiced where each of the aggregated data items is a column.

In embodiments where the dataset is a structured document, some embodiments may be implemented where the query is specified as tabular data.

The method 600 may further include replacing matches for the search objects. In some embodiments, this may be done by replacing matches for the search objects with an object that is a different type than the search object. For example, as illustrated above, a text object may be replaced with an executable formula, image, web service (e.g., a machine learning algorithm that can be used as a web service) or any other content recognized by the spreadsheet program or other program in which embodiments are implemented.

The method 600 may further include receiving input specifying exceptions for bulk replacement of matches for the search object. As a result, when performing a bulk replacement of matches for the search object, the method 600 may include excluding matches marked as exceptions for being replaced. Thus, embodiments may enable and facilitate exception tagging and bulk replacement.

The method 600 may be performed where aggregating data items of the dataset that include a match for the search object includes rearranging sequence of tabular data by aggregating matched entries and displaying the aggregated entries at the top of a spreadsheet or document.

The method 600 may be practiced where at least one match for the search object is the search object. Thus, embodiments may be practiced where search objects match search results. However, in some embodiments, the method 600 may be practiced where at least one match for the search object is an object related to the search object, but is not the search object itself. For example, the matches may be synonyms, misspellings, strings within some predetermine lexical distance, etc. In some such cases, matches may be sorted by similarity to the search object.

The method 600 may further include receiving user input specifying a replacement object for matches for the search object, and as a result, displaying to the user a preview of the replacement object for one or more of the matches in the active region. Thus, embodiments may allow for previewing replacements in the context in which the replacements will be made.

Referring now to FIG. 7, a method 700 is illustrated. The method 700 may be practiced in a computing environment and includes acts for searching a dataset. The method 700 includes identifying one or more user specified search objects (act 702). The search objects may be, for example, strings, numbers, pictures, formulas, metadata, descriptions, type information, etc.

The method 700 includes identifying search results in the dataset based on the search objects according to predetermined result criteria (act 704). Various result criteria will be discussed below.

The method 700 includes sorting the search results according to a similarity measure to the search objects (act 706).

The method 700 includes providing the sorted search results to a user in an active region of a representation of the dataset (act 708).

The method 700 may further include identifying receiving user input of a replacement object and providing a preview of the replacement object in the displayed sorted search results.

Some embodiments of the method 700 may further include receiving user input indicating that certain search entitles should be excluded from replacement operations. Such user input may be indicated using check boxes, selectable x's, select operations, multiple object select operations, etc. As a result of receiving user input indicating that certain search entitles should be excluded from replacement operations, the method 700 may further include excluding the excluded objects from replacement.

The method 700 may be practiced where wherein the result criteria is evaluated according to a predictive algorithm to identify similar objects. Alternatively or additionally, the method 700 may be practiced where the result criteria is evaluated according to a formula that matches a result of the formula. Thus for example, embodiments may be able to sort search results by formulas that produce similar or identical computation results. Alternatively or additionally, the method 700 may be practiced where the result criteria is evaluated according to distance mapping criteria matching similarity of words. Such similarity may be based on synonyms, abbreviations, misspellings, lexical distance, etc.

The method 700 may include sorting the search results according to a similarity measure to the search objects. Displaying the sorted search results to a user may include resorting a main underlying representation of the dataset (e.g., a document) and displaying the resorted underlying representation of the dataset to the user.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include: Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. In a computing environment, a system for efficient searching, the system comprising:
one or more computer processors; and
one or more computer-readable media coupled to the one or more processors, wherein the one or more computer-readable media comprise computer-executable instructions that when executed by at least one of the one or more processors cause the following to be performed:
receiving a query specifying a search object for a dataset comprising data items, wherein the data items in the dataset are able to be viewed or navigated to in an active region of a user interface, wherein the active region is a portion of a display in which is primarily configured for use by a user to view, navigate to for viewing, add, remove or edit the data items in the dataset;
a dataset sort module rearranging the order of the data items in the dataset to aggregate together a subset of the data items that include a match for the search object; and
providing the rearranged dataset, including data items that have a match for the search object and data items that do not have a match for the search object, through the active region of the user interface such that a user can view or navigate to the aggregated data items in the dataset as well as other data items in the dataset.

2. The system of claim 1, wherein the dataset is an unstructured dataset.

3. The system of claim 2, wherein each of the aggregated data items is a paragraph.

4. The system of claim 2, wherein each of the aggregated data items is a sentence.

5. The system of claim 1, wherein the dataset is a structured dataset.

6. The system of claim 5, wherein each of the aggregated data items is a row.

7. The system of claim 5, wherein each of the aggregated data items is a column.

8. The system of claim 5, wherein the query is specified as tabular data.

9. The system of claim 1, the computer readable media further comprising computer executable instructions that when executed by one or more processors cause the system to replace matches for the search object with an object that is a different type than the search object.

10. The system of claim 1, the computer readable media further comprising computer executable instructions that when executed by one or more processors cause the system to receive input specifying exceptions for bulk replacement of matches for the search object, and as a result, when performing a bulk replacement of matches for the search object, exclude matches marked as exceptions for being replaced.

11. The system of claim 1, wherein at least one match for the search object is the search object.

12. The system of claim 1, wherein at least one match for the search object is an object related to the search object, but is not the search object itself.

13. The system of claim 1, the computer readable media further comprising computer executable instructions that when executed by one or more processors cause the system to receive user input specifying a replacement object for matches for the search object, and as a result, display to the user a preview of the replacement object for one or more of the matches in the active region.

14. In a computing environment, a system for searching a dataset comprising data items, the system comprising:
one or more computer processors; and
one or more computer-readable media coupled to the one or more processors, wherein the one or more computer-readable media comprise computer-executable instructions that when executed by at least one of the one or more processors cause the following to be performed:
identifying one or more user specified search objects;
a search engine identify search results in the dataset based on the search objects according to predetermined result criteria;
sorting the search results according to a similarity measure to the search objects by rearranging the order of the data items in the dataset; and
providing the sorted search results to an active region of a user interface, wherein the active region is a portion of a display in which is primarily configured for use by a user to view, navigate to for viewing, add, remove or edit the data items in a dataset.

15. The method of claim 14, further comprising receiving user input of a replacement object and providing a preview of the replacement object in the displayed sorted search results.

16. The method of claim 14 or claim 15, further comprising receiving user input indicating that certain search entitles should be excluded from replacement operations and as a result excluding the excluded objects from replacement.

17. The method of claim 14, wherein the result criteria is evaluated according to a predictive algorithm to identify similar objects.

18. The method of claim 14, further comprising sorting the search results according to a similarity measure to the search objects; and wherein displaying the sorted search results to a user comprises resorting a main underlying representation of the dataset and displaying the resorted underlying representation of the dataset to the user.

19. In a computing environment, a method for efficient display of search results to a user, the method comprising:
receiving a query specifying a search object for a dataset comprising data items, wherein the data items in the dataset are able to be viewed or navigated to in an active region of a user interface, wherein the active region is a portion of a display in which is primarily configured for use by a user to view, navigate to for viewing, add, remove or edit the data items in the dataset;
a dataset sort module rearranging the order of the data items in the dataset to aggregate together a subset of the data items that include a match for the search object; and
providing the rearranged dataset, including data items that have a match for the search object and data items that do not have a match for the search object through the active region of the user interface such that a user can view or navigate to the aggregated data items in the dataset as well as other data items in the dataset.

20. The method of claim 19, further comprising receiving input specifying exceptions for bulk replacement of matches for the search object, and as a result, when performing a bulk replacement of matches for the search object, excluding matches marked as exceptions for being replaced.

21. In a computing environment, a system for efficient display of search results, the system comprising:
a dataset
means for receiving a query specifying a search object for a dataset, wherein data items in the dataset are able to be viewed or navigated to in an active region of a user interface, wherein the active region is a portion of a display in which is primarily configured for use by a user to view, navigate to for viewing, add, remove or edit the data items in the dataset;
means for rearranging the order of the data items in the dataset to aggregate together a subset of the data items that include a match for the search object; and
means for providing the rearranged dataset, including data items that have a match for the search object and data items that do not have a match for the search object through the active region of the user interface, such that a user can view or navigate to the aggregated data items in the dataset as well as other data items in the dataset.

22. The system of claim 21, wherein the dataset is an unstructured dataset.

23. The system of claim 22, wherein each of the aggregated data items is a paragraph.

24. The system of claim 22, wherein each of the aggregated data items is a sentence.

25. The system of claim 21, wherein the dataset is a structured dataset.

26. The system of claim 25, wherein each of the aggregated data items is a row.

27. The system of claim 25, wherein each of the aggregated data items is a column.

28. The system of claim 25, wherein the query is specified as tabular data.

29. In a computing environment, a method for efficient display of a document to display search results in context in the document to a user, the method comprising:
displaying a document in an active region of a display, the document comprising a plurality of sentences or paragraphs, wherein the active region is a portion of the display in which is primarily configured for use by a user to view, navigate to for viewing, add, remove or edit the sentences or paragraphs in the document;
receiving a query specifying a search object to be found in the document;
identifying sentences or paragraphs in the document with an instance matching the received query;
rearranging the order of the sentences or paragraphs in the document such that sentences or paragraphs for the document are grouped where paragraphs with an instance of a search result for the query are grouped together; and
providing the rearranged document through the active region of the user interface such that a user can view or navigate to the rearranged sentences or paragraphs in the document.

30. The method of claim 29, wherein providing the rearranged document through the active region of the user interface comprises providing all of the sentences or paragraphs in the document such that all of the sentences or paragraphs in the document can still be viewed or navigated to, such that sentences or paragraphs from the document are rearranged, but not filtered out of the document.

31. The method of claim 29, wherein providing the rearranged document through the active region of the user interface comprises providing sentences or paragraphs in the document such that sentences or paragraphs in the document with search results that match the search object are displayed or able to be navigated to in the active region at the top of a document, while sentences or paragraphs not having search results that match the search object are displayed or able to be navigated to below the sentences or paragraphs in the document with search results that match the search object.

32. The method of claim 29, wherein providing the rearranged document through the active region of the user interface comprises providing sentences or paragraphs sorted according to how close one or more elements in the sentences or paragraphs are to the search objects.

33. A system comprising:
one or more computer processors; and
one or more computer-readable media having stored thereon instructions that are executable by the one or more processors to configure the computer system to efficiently display a document to display search results in context in the document to a user, including instructions that are executable to configure the computer system to perform at least the following:
displaying a document in an active region of a display, the document comprising a plurality of sentences or paragraphs, wherein the active region is a portion of the display in which is primarily configured for use by a user to view, navigate to for viewing, add, remove or edit the sentences or paragraphs in the document;
receiving a query specifying a search object to be found in the document;
identifying sentences or paragraphs in the document with an instance matching the received query;
rearranging the order of the sentences or paragraphs in the document such that sentences or paragraphs for the document are grouped where paragraphs with an instance of a search result for the query are grouped together; and
providing the rearranged document through the active region of the user interface such that a user can view or navigate to the rearranged sentences or paragraphs in the document.

34. The system of claim 33, wherein providing the rearranged document through the active region of the user interface comprises providing all of the sentences or paragraphs in the document such that all of the sentences or paragraphs in the document can still be viewed or navigated to, such that sentences or paragraphs from the document are rearranged, but not filtered out of the document.

35. The system of claim 33, wherein providing the rearranged document through the active region of the user interface comprises providing sentences or paragraphs in the document such that sentences or paragraphs in the document with search results that match the search object are displayed or able to be navigated to in the active region at the top of a document, while sentences or paragraphs not having search results that match the search object are displayed or able to be navigated to below the sentences or paragraphs in the document with search results that match the search object.

36. The system of claim 33, wherein providing the rearranged document through the active region of the user interface comprises providing sentences or paragraphs sorted according to how close one or more elements in the sentences or paragraphs are to the search objects.
